(19) United States
(12) Patent Application Publication
(10) Pub. No.: US 2023/0394326 A1
(43) Pub. Date: Dec. 7, 2023

(54) PARTIAL IMPORTANCE OF INPUT VARIABLE OF PREDICTIVE MODELS

(71) Applicant: International Business Machines Corporation, Armonk, NY (US)

(72) Inventors: Si Er Han, Xi'an (CN); Xue Ying Zhang, Xi'an (CN); Xiao Ming Ma, Xi'an (CN); Wen Pei Yu, Xi'an (CN); Jing Xu, Xi'an (CN); Jing James Xu, Xi'an (CN); Rui Wang, Xi'an (CN)

(21) Appl. No.: 17/804,935

(22) Filed: Jun. 1, 2022

(51) Int. Cl. G06N 5/02

(52) U.S. Cl. CPC G06N 5/022

(57) ABSTRACT

Embodiments of the present disclosure relate to a method, system, and computer program product for predictive models. According to the method, a processor may provide a first list including at least one input variable of a predictive model and a second list including a plurality of variables of the predictive model. For each of input variables in the second list, the processor may determine contribution of the input variable to prediction of the predictive model with respect to the at least one input variable in the first list. The processor may update the first list by moving an input variable in the second list into the first list based on the determined contribution of the plurality of input variables. The processor may render one or more of input variables in the updated first list based on an order of the input variables in the updated first list.

### BACKGROUND

The present disclosure relates to machine learning, and more particularly, to a method, system, and computer program product for determining and visualizing partial importance of input variables of predictive models.

Predictive models have useful applications in various settings. For example, in fraud detection, the predictive models can model the likelihood that an individual has made a fraudulent claim based on data associated with the individual's claim. As another example, in healthcare, the predictive models can output the probability that a patient might be diagnosed with a certain condition. In many instances, a variety of predictive models may be applied to a given setting.

Effort has been made to explain the predictive models instead of considering the models as black boxes. Variable importance (VI) is investigated to provide insight to the predictive models, which may indicate impact of each input variable on the outcome of the predictive models.

### SUMMARY

According to one embodiment of the present disclosure, there is provided a computer-implemented method. According to the method, a processor may provide a first list including at least one input variable of a predictive model and a second list including a plurality of input variables of the predictive model. For each of input variables in the second list, the processor may determine contribution of the input variable to prediction of the predictive model with respect to the at least one input variable in the first list. The processor may update the first list by moving an input variable from the second list into the first list based on the determined contribution of the plurality of input variables. The processor may render one or more of input variables in the updated first list based on an order of the input variables in the updated first list.

According to a further embodiment of the present disclosure, there is provided a system. The system comprises a processor; and a computer-readable storage medium communicatively coupled to the processor and storing program instructions which, when executed by the processor, cause the processor to perform a method according to embodiments of the present disclosure.

According to a yet further embodiment of the present disclosure, there is provided a computer program product comprising a computer-readable storage medium having program instructions embodied therewith, the program instructions executable by a processor to cause the processor to perform a method according to embodiments of the present disclosure.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 depicts a cloud computing node according to some embodiments of the present disclosure.

FIG. 2 depicts a cloud computing environment according to some embodiments of the present disclosure.

FIG. 3 depicts abstraction model layers according to some embodiments of the present disclosure.

FIG. 4 depicts a block diagram of an example environment in which some embodiments of the present disclosure may be implemented.

FIG. 5 depicts a block diagram of an example model analysis engine according to some embodiments of the present disclosure.

FIG. 6A depicts an example set of records according to some embodiments of the present disclosure.

FIG. 6B depicts a bar chart showing example variable importance of a predictive model according to some embodiments of the present disclosure.

FIG. 7 depicts a flowchart of an example process according to some embodiments of the present disclosure.

FIG. 8 depicts a flowchart of an example process according to some embodiments of the present disclosure.

FIGS. 9A and 9B depict diagrams of an example process for determining partial importance according to some embodiments of the present disclosure.

FIGS. 10A and 10B depict example visual elements showing correlation information between variables of a predictive model according to some embodiments of the present disclosure.

FIG. 11 depicts example visual elements showing variables of the predictive model based on partial importance according to some embodiments of the present disclosure.

FIG. 12 depicts a flowchart of an example process according to some embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

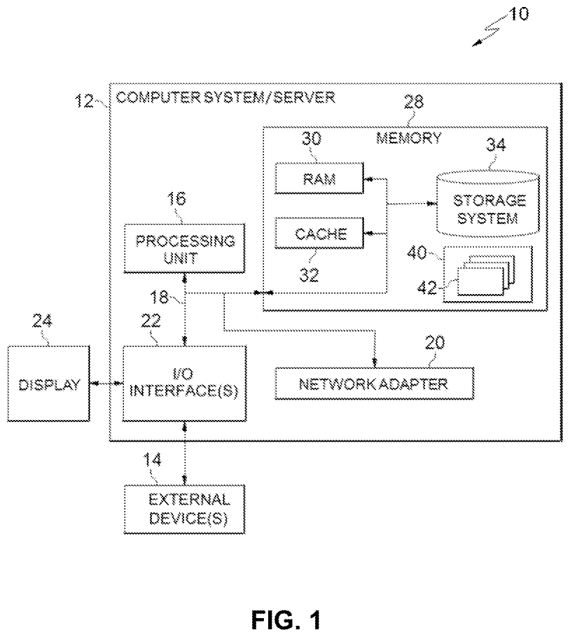

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

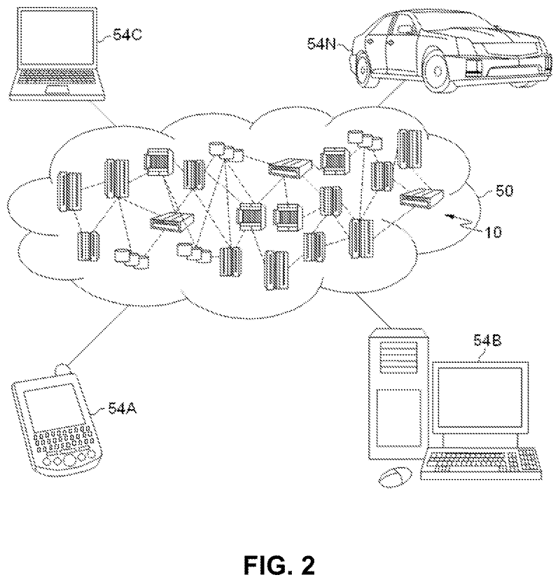

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

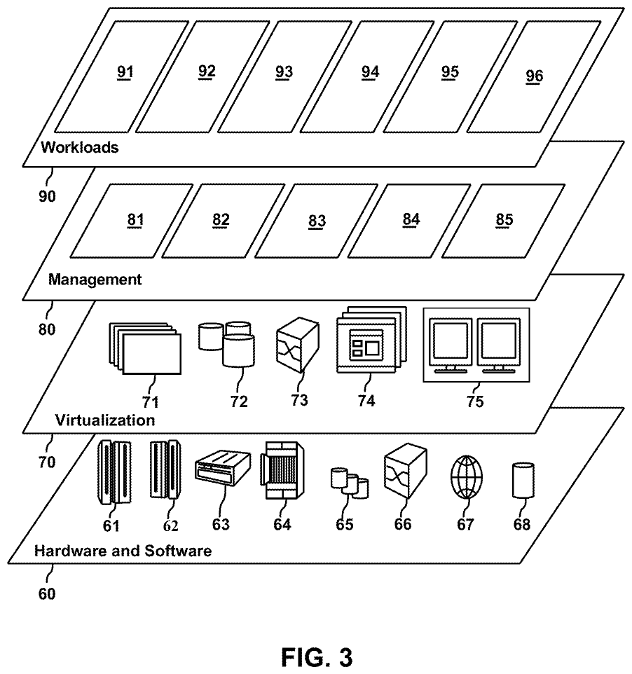

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and model analysis engine 96. The functionalities of model analysis engine 96 will be described in the following embodiment of the present disclosure.

Variable importance (VI) refers to how much a given model “uses” that variable to make accurate predictions. The more a model relies on a variable to make predictions, the more important it is for the model. VI helps data scientists weed out certain predictors that are contributing nothing and that instead add time to processing. VI is typically calculated by the sum of the decrease in error when split by a variable. However, problem occurs when two or more variables are correlated with each other. Although each of them has high VI value when calculated independently, their contribution to the modeling can be mostly represented by any one of them, and the rest are redundant to the model.

In view of above, a system and method for partial importance computation and visualization are provided, from which redundant important predictors or variables are automatically identified and visualized to provide insights to users. It is noted that in some context, terms “predictor”, “feature”, “variable” and “input variable” may be interchangeably used.

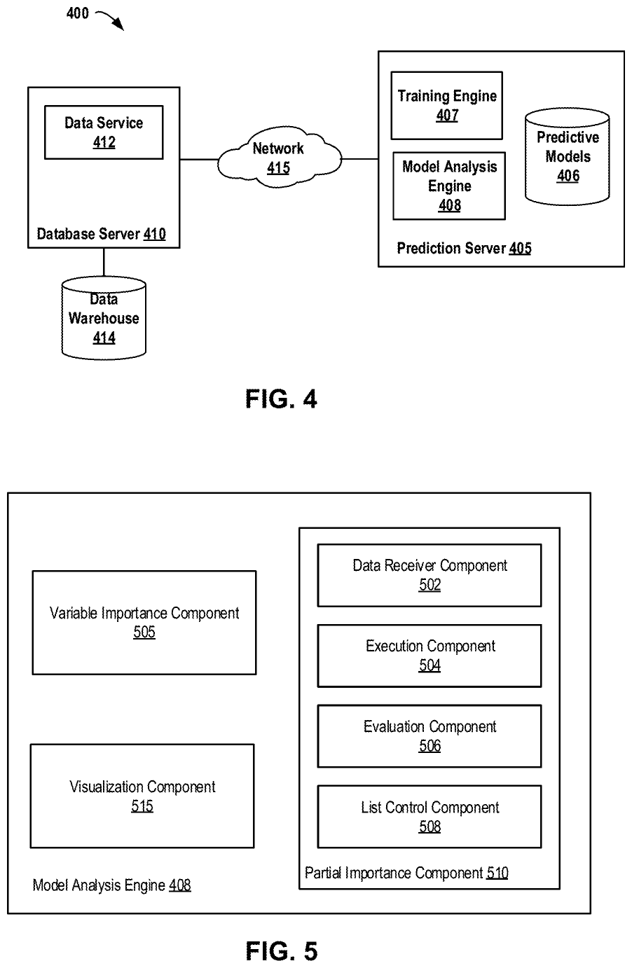

FIG. 4 illustrates a block diagram of an example environment 400 in which some embodiments of the present disclosure may be implemented. As shown, the environment 400 includes a prediction server 405 and a database server 410 which are connected via a network 415. Each of the prediction server 405 and database server 410 may correspond to a physical computing system (e.g., a desktop computer, workstation, laptop device, etc.) or a virtual computing instance executing on a cloud network. Further, although FIG. 4 depicts the configuration of software components as executing on separate servers, the components may all reside on one system (e.g., as a single application, as multiple applications, etc.)

In one embodiment, the prediction server 405 includes predictive models 406 that may forecast outcomes from a set of data records. A data record may be represented by a combination of variables, namely, a vector. Examples of predictive models may include random forest, decision tree, support vector machine, neutral network, and the like. The predictive model may have input nodes to receive values for the variables of a data record, and calculate a probability for the data record based on internal parameters.

In an example, assume that the environment 400 corresponds to an enterprise that processes loan applications for individuals. The enterprise may want to determine a likelihood that a given individual may default on a loan. Relevant variables for determining such likelihood may include credit history, age, occupation, salary, requested amount, number of people in the individual's household, and the like. In this example, the enterprise may obtain that information from the individual (e.g., provided through the loan application that the individual completes).

Further, a database service 412 (executing on the database server 410) may store data records on a database, such as in a data warehouse 414. The data warehouse 414 may provide modeling data organized by variables used for input to a predictive model. In one embodiment, the database service 412 corresponds to a relational database application that manages access to the data records. For example, the prediction server 405 may access data records using database queries from the data warehouse 414, and the database service 412 may return the corresponding data, e.g., as a markup language file (e.g., in XML format).

Further, the data record also includes training data and test data. During the training process, the training engine 407 in the prediction server 405 may use the data records from a training dataset to estimate model parameters and refine the accuracy of the model. The training engine 407 may also use data records from a test dataset to validate the accuracy of the predictive model. Afterwards, the trained model may be used to predict outcomes for new data records. It is noted that data records in the training dataset and the test dataset have labels as ground truth for the predictive model, while the new data records do not have labels. In one embodiment, based on the ground truth, performance of the predictive model may be measured by indicators such as accuracy, precision, recall rate, and combination thereof.

The model analysis engine 408 may be invoked to provide insights to the trained models, including variable importance and partial importance. As further described below, model analysis engine 408 does so by determining partial importance of input variables which removes redundant information about impacts of the input variables on the predictive model. Further, the model analysis engine 408 may generate visualization and/or a summary of the analysis results for presentation to a user.

By doing so, the user may conveniently and intuitively learn about which variables have more influence on outcomes of the predictive model and which variables have less influence, with or without considering correlation between the variables. The user may further remove the variables having less influence from the predictive model. Thus, the size of the predictive model may be reduced, and the execution time of the model may also be reduced. In addition, since the number of input variables is reduced, the data records as input requires less variables accordingly and thus tedious work of data collection may be alleviated.

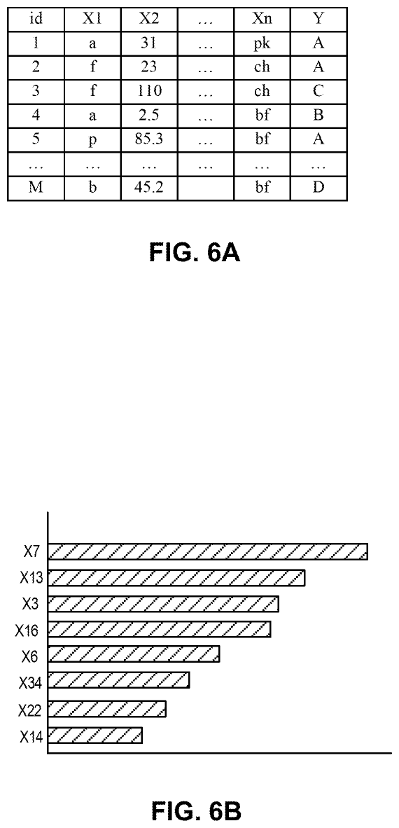

FIG. 5 depicts a block diagram of an example model analysis engine 408 according to some embodiments of the present disclosure. In particular, FIG. 5 presents a conceptual diagram of the process steps performed by the model analysis engine 408. One of skill in the art will recognize that the actual allocation of process steps in practice may vary substantially from this illustration. As shown, the model analysis engine 408 includes a variable importance component 505, a partial importance component 510, and a visualization component 515. For a more detailed explanation, FIG. 5 is further described with FIGS. 6A and 6B.

The variable importance component 505 may determine variable importance of each input variable of the predictive model. As mentioned above, the variable importance measures how much the predictive model “uses” that variable to make accurate predictions. In one embodiment, the variable importance component 505 may mask or randomize values for a given variable of data records, while keeping other input values as they are. Then, variable importance component 505 may calculate the sum of the decrease in error, where a given variable with a relatively large number of errors may indicate that the variable will have a large impact on predictions of the model. By doing so iteratively, the variable importance component 505 may rank all of the variables of the models according to corresponding variable importance.

FIG. 6A depicts an example set of records according to some embodiments of the present disclosure. FIG. 6B depicts a bar chart showing example variable importance of a predictive model.

In FIG. 6A, the set of records may include M records each comprising N variables (X1, X2, . . . Xₙ) and a label Y as ground truth for prediction, for example, classification results.

Further, the variable importance component 505 may output the ranked variables with corresponding variable importance to the visualization component 515, which may visualize variable importance to provide the user with the influence of each variable on prediction of the model. For example, variable importance may be displayed in a bar chart or otherwise.

In FIG. 6B, the variable importance of the predictive model are shown in a bar chart. According to FIG. 6B, variable X7 has the largest variable importance, followed by variable X13, X3, X16 . . . , and so on. It is noted that variable importance can indicate the impact of the variable, per se, on the model. In a case where two or more variables on top of the bar chart are correlated, there is redundant information among the variable importance. For example, to determine or predict whether an individual may default on loan, salary and education may both have relatively large impact on the predictions of the model. However, salary and education are generally correlated, that is, it may be not necessary to collect individual data for both.

Refer back to FIG. 5. The partial importance component 510 may provide insight to the predictive model by considering correlations between the input variables of the predictive models. In particular, the partial importance component 510 may determine the partial importance of the input variables. According to some embodiments, the partial importance may measure additional contribution of an input variable to prediction of the predictive model with respect to one or more other input variables. In other words, by indicating “net” impact of the variable on the model, the partial importance reveals the underlying correlation between the variable in consideration and other input variables.

As shown, the partial importance component 510 includes a data receiver component 502, execution component 504, evaluation components 506, and a list control component 508.

In one embodiment, the data receiver component 502 may access the database server 410 to receive a set of data records for determining partial importance. The data records received from databased server 410 may include values for respective input variables (for example, X1-Xn as in FIG. 6A) and a label as ground truth (for example, Y as in FIG. 6A). Alternatively, the data receiver component 502 may obtain the data records based on predictions of the model. That is, the ground truth may be the outcomes of predictive model other than from database server 410. It is noted that the set of data records to be used by the partial importance component are not necessarily the records which are used by the variable importance component 505.

The execution component 504 may adjust the predictive model and further provide data records as input to the adjusted predictive model. Then the adjusted predictive model may generate predictions for the data records. In one embodiment, the execution component 504 may enable specified input variable(s), and disable rest input variables of the model. By traversing the data records, the predictive model may generate predictions with a derivation from the ground truth because the inputted data records are incomplete.

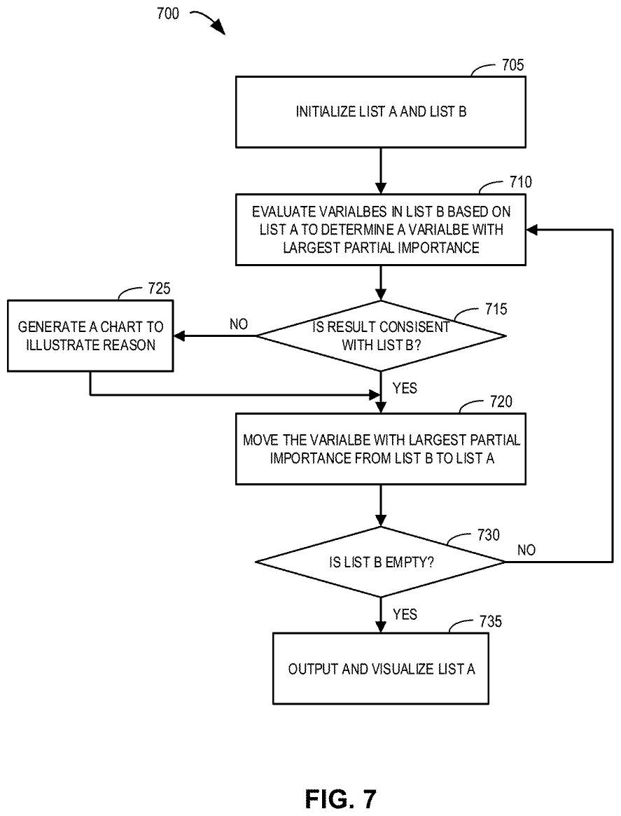

In one embodiment, the input variables to be enabled may be determined based on lists maintained by list control component 508. The list control component 508 may control two lists including input variables of the predictive model: one for partial importance, the other for variable importance. Generally, the execution component 504 may enable all input variables in the partial importance list and one input variable in the variable importance list to determine the partial importance, that is, “net” contribution of the variable in the variable importance list relative to the variables in the partial importance list. Details will be further described with reference to FIGS. 7-12.

The evaluation component 506 may evaluate the partial importance of the input variable based on the performance improvement of predictive model that is introduced by the input variable. In one embodiment, the performance may be determined as accuracy of the predictive model. The evaluation component 506 may further output the evaluated partial importance to the list control component 508.

As mentioned above, list control component 508 maintains the variable importance list and the partial importance list. In one embodiment, the list control component 508 may adjust the two lists based on output of the evaluation component 506, for example, by picking input variable from the variable importance list and placing into the partial importance list. Details will be further described with reference to FIGS. 7-12.

In the model analysis engine 408, the visualization component 515 may generate user interfaces to shown analysis results, for example, the input variables with evaluated partial importance and/or variable importance, correlation information between the input variables.

FIG. 7 depicts a flowchart of an example process 700 according to some embodiments of the present disclosure. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

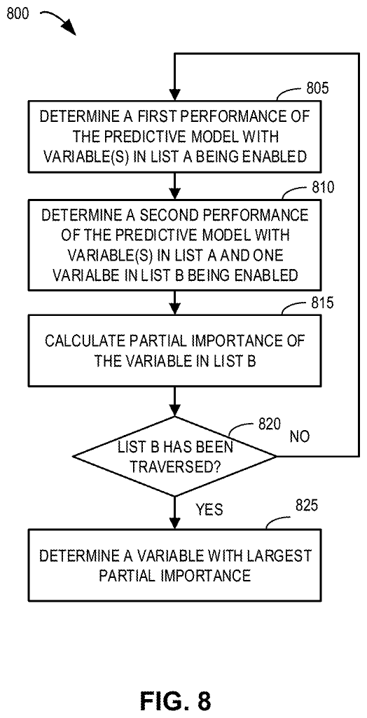

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like. In one embodiment, the process 700 may implanted by the prediction server 405, in particular, by the model analysis engine 408 as shown in FIG. 4. For understanding the embodiments of the disclosure, FIG. 7 will be described with reference to FIGS. 8-11.

At block 705, the model analysis engine 408 initiates a first list (namely list A) and a second list (namely list B). The list A and the list B may be created and initiated by the list control component 508. The list A and the list B may be configured to store and rank input variables of the predictive. In one embodiment, the list A may be configured to rank the input variables in accordance with the partial importance, while the list B may be configured to rank the input variables in accordance with the variable importance.

To initiate the list A and the list B, the model analysis engine 408 may invoke variable importance component 505 to calculate variable importance of the input variables of the predictive model. Alternatively, the variable importance may have been calculated and stored by the variable importance component 505. Based on the variable importance, the model analysis engine 408 may put an input variable with largest variable importance into list A, and put rest of the input variables into the list B. In one embodiment, the input variables in the list B may be arranged in accordance with variable importance as determined by the variable importance component 505.

At block 710, the model analysis engine 408 evaluates variables in the list B based on the list A to determine a variable with largest partial importance. In one embodiment, the input variables in the list B are traversed to find out which variable in the list B has the largest partial importance.

As mentioned above, the concept of partial importance is employed to measure the additional contribution of a variable to the prediction of the predictive model relative to one or more other input variables. By way of incorporating the variable in the predictive model, the performance of the predictive model may be improved. In other word, the variable contributes to prediction of the model with respect to the previously enabled variables of the model.

FIG. 8 depicts a flowchart of example process 800 for determining the variable having the largest partial importance. The process 800 may be performed at block 710.

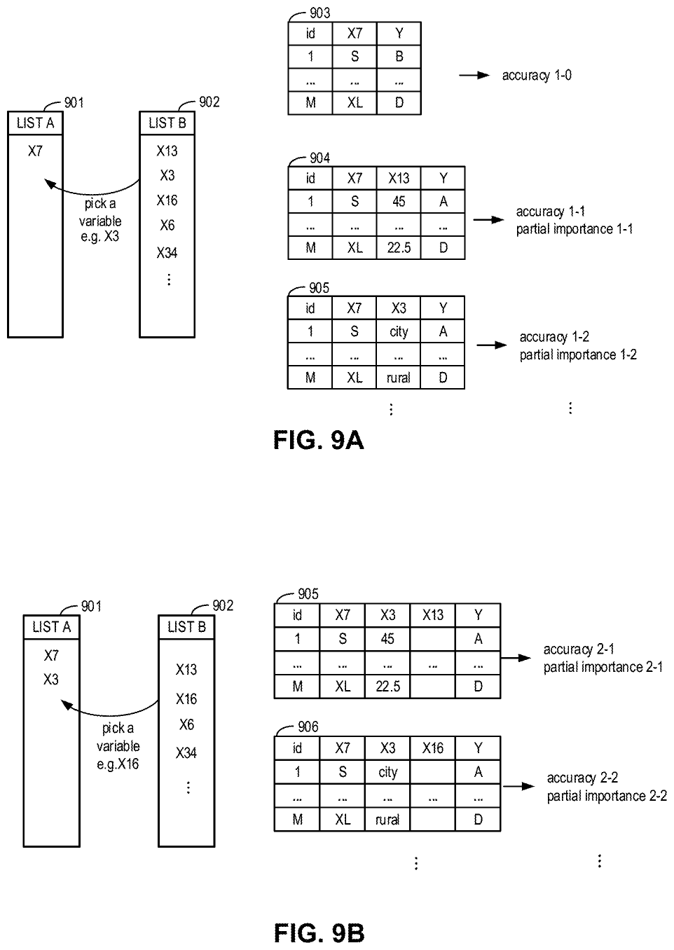

At block 805, the model analysis engine 408 determines a first performance of the predictive model with the variable(s) in the list A being enabled. Referring to FIG. 9A, at the beginning, the list A 901 has one variable, X7, which has the largest variable importance among the variables of the predictive model, while the list B 902 has rest of the variables, X13, X3, X16, . . . , with decreasing variable importance.

The model analysis engine 408 may input a set of records to the predictive model to generate predictions for the data records. As shown in table 903, only X7 is enabled, that is, other variables do not contribute to the outcome of the model. The predictive model may output predictions Y for the data records based on values for variable X7. In one embodiment, the predictions may be compared with the ground truth of the data records to determine the performance of the model as accuracy. Thus, the first performance may be determined to be accuracy 1-0 as in FIG. 9A.

At block 810, the model analysis engine 408 determines a second performance of the predictive model with the variable(s) in the list A and one variable in list B being enabled. Referring to FIG. 9A again, as shown in table 904, variables X7 and X13 are enabled for the predictive model. The predictive model may output predictions Y for the data records based on values for variables X7 and X13. Accordingly, the second performance may be determined to be accuracy 1-1 by comparing the predictions with the ground truth of the data records.

At block 815, the model analysis engine 408 calculates the partial importance of the variable(s) in the list B. In one embodiment, the partial importance of the variable in consideration in the list B (here X13) may be determined by a comparison between the second performance and the first performance. For example, the partial importance 1-1 of variable X13 may be determined to be a difference between accuracy 1-1 and the accuracy 1-0 or a ratio of accuracy 1-1 to the accuracy 1-0.

Next, at block 820, the model analysis engine 408 determines whether the list B has been traversed. If the list B has not been traversed yet, “NO” at block 820, the process 800 may return to block 805 and calculate the partial importance of the next variable in the list B. For example, as shown in table 905, the partial importance 1-2 of variable X3 is calculated.

If the list B has been traversed, “YES” at block 820, the model analysis engine 408 determines a variable with largest partial importance, at block 825.

Refer back to FIG. 7. At block 715, the model analysis engine 408 determines whether the result is consistent with the list B. As mentioned above, the variables in the list B are ranked according to variable importance. When the variable with the largest partial importance is exactly the top variable in the list B, it is determined that the result is consistent with the list B, “YES” at block 715, and the process proceeds to block 720, the variable is moved from the list B into the list A.

When the result is not consistent with the list B, “NO” at block 715, the process 700 proceeds to block 725, where the model analysis engine 408 generates a chart to illustrate the reason. In this case, the variable with the largest partial importance is not the top variable in the list B. The top variable in the list B may be highly correlated with one or more of the variables in the list A, and correlation reduces the contribution of the variable per se to the prediction of the predictive model. With the generated chart, the user may learn the correlations between the variables which cause the inconsistence between the partial importance and the variable importance.

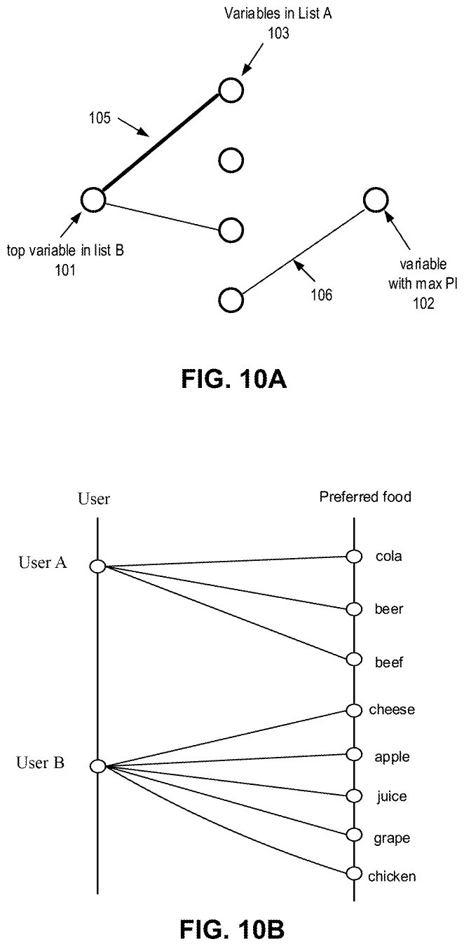

Referring now to FIG. 10A, which depicts example visual elements showing correlation information between variables of a predictive model. In FIG. 10A, illustrated are a node 101 representing the top variable in the list B, a set of nodes 103 representing variables in the list A, and a node 102 representing the variable with largest partial importance.

In FIG. 10A, edges 105 and 106 between the nodes indicate the correlation information between the nodes. For example, the thick edge 105 connecting node 101 and one of the nodes 103 indicates that the top variable in the list B is highly correlated with that the variable represented by that node. The thin edge 106 connecting the node 102 and another node of the nodes 103 indicates that the variable with largest partial importance is less correlated with the variables in the list A.

In one embodiment, the user may interact with the visual elements. For example, the user may click the edges 105 or 106 to find detailed correlation information. FIG. 10B illustrates an example parallel chart which depicts detailed correlation information between variables. As shown, a variable “User” includes values “User A” and “User B”, and another variable “preferred food” includes values “cola”, “beer”, “beef”, and etc. In the parallel chart, the edges between values of the variables represent a data record have corresponding values. In addition, the edges may have weights. The weights may be the number of data records which have values at the ends.

Referring back to FIG. 7, if it is determined that the result is consistent with the list A, in other words, the variable with largest in the list B is exactly the top variable in the list B, the process 700 proceeds to block 720.

At block 720, the model analysis engine 408 moves the variable with largest partial importance into the list A. For example, variable X3 has the largest partial importance and is moved into the list A, as shown in FIG. 9A.

Next, at block 730, the model analysis engine 408 determines whether the list B is empty. If there is one or more variables in the list B, “NO” at block 730, the process 700 returns to block 710. The model analysis engine 408 may perform the acts in blocks 710 to 720 iteratively. It may calculate partial importance of the variables in the list B and pick a variable in the list B which has largest partial importance with respect to the updated list A.

Refer to FIG. 9B which illustrates the second round of the loop. The list A now has two variables, X7 and X3, while the list B has variables X13, X16 . . . which are ranked according to variable importance. As shown in tables 905 and 906, by enabling variables in the list A (X7 and X3) together with one of each variable in the list B (e.g., X13, X16 . . . ), the performance of the predictive model is determined. Accordingly, the partial importance of each variable in the list B is determined. By doing so, each and every variable in the list B is moved into the list A until the list B is empty. It is noted that the variables in the list A are ranked in accordance with the partial importance of the variables.

At block 735, the model analysis engine 408 outputs and visualizes the variables in the list A. In one embodiment, one or more of the variables in the list A may be identified based on the order of the variables in the list A. For example, top P (P is an integer larger than 1 and less than the number of variables of the model) variables in the list A may be identified as important variables of the predictive model. Since correlation among the variables is considered when constructing the list A, a combination of variables at top positions of the list A has more contribution to the predictions of the predictive model than the same number of variables in list B. By the use of the partial importance, the predictive model may be more effectively explained and optimized.

In one embodiment, the user may reduce the size of the predictive model by removing input nodes relating to variables other than the identified ones and in turn removing related parameters from the predictive model.

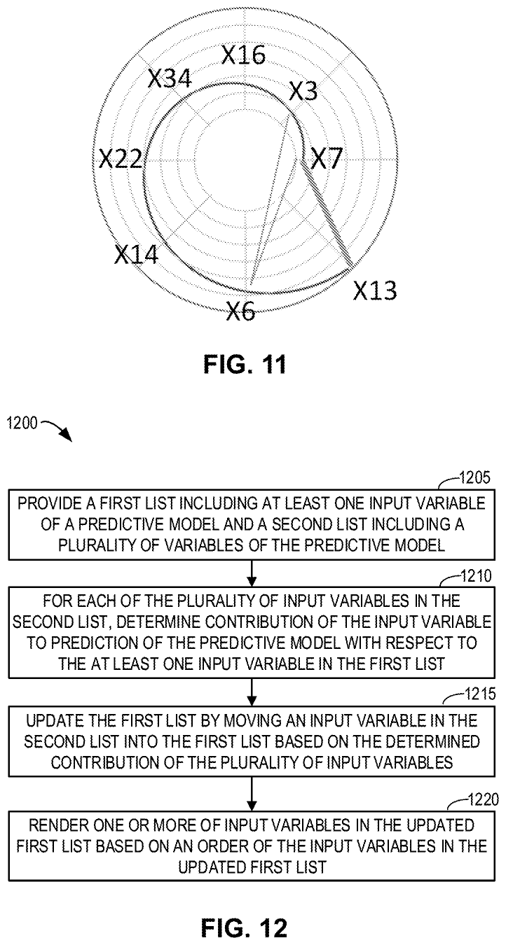

In one embodiment, the identified variables of the predictive model may be visualized according to partial importance. FIG. 11 depicts example visual elements showing variables according to the list A. In FIG. 11, the variables are represented by nodes on a spiral. The distance of a node from the center of the spiral indicates partial importance of the corresponding variable. As shown in FIG. 11, X7 is the top variable in the list A and thus closest to the center, while X14 has the least partial importance among the variables in FIG. 11.

In FIG. 11, the correlation information between the variables may also be shown by the edges between the nodes. Similar to FIG. 10A, edges between nodes indicate that the corresponding variables are correlated with each other. The thickness of an edge may indicate the level of correlation. As shown in FIG. 11, X13 is highly correlated with X7, while X6 is correlated with X7 and X13, but the correlation is not as strong as that between X7 and X13. Since X13 provides less contribution than other variables in sense of partial importance, it is placed outmost on the spiral.

In addition, variables of the predictive model may also be visualized based on variable importance, that is, order in the original list B.

FIG. 12 shows a flowchart of an example method 1200 according to some embodiments of the present disclosure. The method 1200 can be implemented at the model analysis engine 408 of FIG. 4.

At block 1205, the model analysis engine 408 provides a first list including at least one input variable of a predictive model and a second list including a plurality of variables of the predictive model.

In one embodiment, the model analysis engine 408 may determine variable importance of each of input variables of the predictive model, initiate the first list by adding an input variable with largest variable importance into the first list, and initiate the second list by adding the input variables of the predictive model other than the input variable with largest variable importance into the second list in accordance with the determined variable importance.

At block 1210, the model analysis engine 408 determines, for each of the plurality of input variables in the second list, contribution of the input variable to prediction of the predictive model with respect to the at least one input variable in the first list. The contribution of the input variable may be referred as partial importance.

In one embodiment, the model analysis engine 408 may determine a first performance of the predictive model with the at least on input variable in the first list being enabled, determine a second performance of the predictive model with the at least one input variable in the first list together with the input variable being enabled, and determine the contribution of the input variable based on comparison of the first performance and the second performance. In one embodiment, the first performance and the second performance may indicate accuracy of the predictive model.

At block 1215, the model analysis engine 408 updates the first list by moving an input variable in the second list into the first list based on the determined contribution of the plurality of input variables in the second list. In one embodiment, the model analysis engine 408 may move a first input variable with largest contribution from the second list into the first list.

In one embodiment, the model analysis engine 408 may determine whether the first input variable has largest variable importance in the second list, and in accordance with a determination that the first input variable does not have largest contribution in the second list, the model analysis engine 408 may cause to display correlation information of the first input variable with the at least one variable in the first list and/or correlation information of a second input variable with the at least one variable in the first list, the second input variable having largest variable importance in the second list.

In one embodiment, the correlation information of the second variable with the variables in the first list may be represented by one or more edges between a node representing the second input variable and nodes representing at least one input variable in the first list.

At block 1220, the model analysis engine 408 may further render one or more of input variables in the updated first list based on an order of the input variables in the updated first list. In one embodiment, rendering the one or more of the input variables may be responsive to a determination that the second list is empty, and may comprise visualizing the one or more input variables in the first list based on the order of the input variables in the first list.

In one embodiment, visualizing the input variables in the first list may comprise causing to display nodes on a spiral representing the input variables in the first list and causing to display one or more edges between the nodes representing correlations of the variables.

It should be noted that the model analysis engine 408 according to embodiments of this disclosure could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

According to one embodiment of the present disclosure, there is provided a computer-implemented method. According to the method, one or more processors provide a first list including at least one input variable of a predictive model and a second list including a plurality of input variables of the predictive model. For each of input variables in the second list, the one or more processors determine contribution of the input variable to prediction of the predictive model with respect to the at least one input variable in the first list. The one or more processors update the first list by moving an input variable in the second list into the first list based on the determined contribution of the plurality of input variables. The one or more processors render one or more of input variables in the updated first list based on an order of the input variables in the updated first list.

According to a further embodiment of the present disclosure, there is provided a system. The system comprises a processing unit; and a memory coupled to the processing unit and storing instructions thereon. The instructions, when executed by the processing unit, perform acts of the method according to the embodiment of the present disclosure.

According to a yet further embodiment of the present disclosure, there is provided a computer program product being tangibly stored on a non-transient machine-readable medium and comprising machine-executable instructions. The instructions, when executed on a device, cause the device to perform acts of the method according to the embodiment of the present disclosure.

What is claimed is:

1. A computer-implemented method comprising:
providing a first list including at least one input variable of a predictive model and a second list including a plurality of input variables of the predictive model;
for each input variable of the plurality of input variables in the second list, determining contribution of the input variable to prediction of the predictive model with respect to the at least one input variable in the first list;
updating the first list by moving an input variable from the second list into the first list based on the determined contribution of each input variable of the plurality of input variables; and
rendering one or more input variables in the updated first list based on an order of the input variables in the updated first list.

2. The computer-implemented method of claim 1, wherein providing the first list and the second list of input variables of the predictive model comprises:
determining variable importance of each of the input variables of the predictive model;
initiating the first list by adding an input variable with a largest variable importance into the first list; and
initiating the second list by adding the input variables of the predictive model other than the input variable with the largest variable importance into the second list in accordance with the determined variable importance.

3. The computer-implemented method of claim 1, wherein determining contribution of the input variable to prediction of the predictive model with respect to the at least one input variable in the first list further comprises:
determining a first performance of the predictive model with the at least one input variable being enabled;
determining a second performance of the predictive model with the at least one input variable together with a first input variable of the plurality of input variables being enabled; and
determining, based on comparison of the first performance and the second performance, the contribution of the input variable.

4. The computer-implemented method of claim 3, wherein the first performance and the second performance indicate accuracy of the predictive model.

5. The computer-implemented method of claim 1, wherein moving an input variable from the second list into the first list based on the determined contribution of the plurality of input variables comprises:
moving a first input variable with a largest contribution from the second list into the first list.

6. The computer-implemented method of claim 5, the method further comprising:
determining whether the first input variable has a largest variable importance in the second list; and
in accordance with a determination that the first input variable does not have the largest variable importance in the second list, displaying at least one of:
correlation information of the first input variable with the at least one input variable in the first list; and
correlation information of a second input variable with the at least one input variable in the first list, the second input variable having the largest variable importance in the second list.

7. The computer-implemented method of claim 6, wherein:
the correlation information of the second variable with the at least one input variable in the first list is represented by one or more edges between a node representing the second input variable and nodes representing the at least one input variable in the first list.

8. The computer-implemented method of claim 1, wherein rendering one or more of input variables in the updated first list further comprises:
determining whether the second list is empty; and
in accordance with a determination that the second list is empty, visualizing the input variables in the first list based on the order of the input variables in the first list.

9. The computer-implemented method of claim 8, wherein visualizing the input variables in the first list based on the order of the input variables in the first list comprises:
displaying nodes on a spiral representing the input variables in the first list; and
displaying one or more edges between the nodes representing correlations of the variables.

10. A system comprising:
a processor; and
a computer-readable storage medium communicatively coupled to the processor and storing program instructions which, when executed by the processor, cause the processor to perform a method comprising:
providing a first list including at least one input variable of a predictive model and a second list including a plurality of input variables of the predictive model;
for each input variable of the plurality of input variables in the second list, determining contribution of the input variable to prediction of the predictive model with respect to the at least one input variable in the first list;
updating the first list by moving an input variable from the second list into the first list based on the determined contribution of each input variable of the plurality of input variables; and
rendering one or more of input variables in the updated first list based on an order of the input variables in the updated first list.

11. The system of claim 10, wherein providing the first list and the second list of input variables of the predictive model comprises:
determining variable importance of each of the input variables of the predictive model;
initiating the first list by adding an input variable with a largest variable importance into the first list; and
initiating the second list by adding the input variables of the predictive model other than the input variable with the largest variable importance into the second list in accordance with the determined variable importance.

12. The system of claim 10, wherein determining contribution of the input variable to prediction of the predictive model with respect to the at least one input variable in the first list further comprises:
determining a first performance of the predictive model with the at least one input variable in the first list being enabled;
determining a second performance of the predictive model with the at least one input variable in the first list together with a first input variable of the plurality of input variables being enabled; and
determining the contribution of the input variable based on comparison of the first performance and the second performance.

13. The system of claim 12, wherein the first performance and the second performance indicate accuracy of the predictive model.

14. The system of claim 10, wherein moving an input variable from the second list into the first list based on the determined contribution of the plurality of input variables comprises:
moving a first input variable with a largest contribution from the second list into the first list.

15. The system of claim 14, wherein the method performed by the processor further comprises:
determining, whether the first input variable has the largest variable importance in the second list; and
in accordance with a determination that the first input variable does not have the largest variable importance in the second list, displaying at least one of:
correlation information of the first input variable with the at least one input variable in the first list; and
correlation information of a second input variable with the at least one input variable in the first list, the second input variable having the largest variable importance in the second list.

16. The system of claim 15, wherein the correlation information of the second variable with the at least one variable in the first list is represented by one or more edges between a node representing the second input variable and nodes representing the at least one input variable in the first list.

17. The system of claim 10, wherein rendering one or more of the input variables in the updated first list further comprises:
determining whether the second list is empty; and
in accordance with a determination that the second list is empty, visualizing the input variables in the first list based on the order of the input variables in the first list.

18. The system of claim 17, wherein visualizing the input variables in the first list based on the order of the input variables in the first list comprises:
displaying nodes on a spiral representing the input variables in the first list; and
displaying one or more edges between the nodes representing correlations of the variables.

19. A computer program product comprising a computer-readable storage medium having program instructions embodied therewith, the program instructions executable by a processor to cause the processor to perform a method comprising:
providing a first list including at least one input variable of a predictive model and a second list including a plurality of input variables of the predictive model;
for each input variable of the plurality of input variables in the second list, determining contribution of the input variable to prediction of the predictive model with respect to the at least one input variable in the first list;
updating the first list by moving an input variable from the second list into the first list based on the determined contribution of each input variable of the plurality of input variables; and
rendering one or more of input variables in the updated first list based on an order of the input variables in the updated first list.

20. The computer program product of claim 19, wherein determining contribution of the input variable to prediction of the predictive model with respect to the at least one input variable in the first list comprises:
determining a first performance of the predictive model with the at least one input variable in the first list being enabled;
determining a second performance of the predictive model with the at least one input variable in the first list together with a first input variable of the plurality of input variables being enabled; and
determining the contribution of the input variable based on comparison of the first performance and the second performance.
